(19) United States
(12) Patent Application Publication
(10) Pub. No.: US 2025/0227426 A1
(43) Pub. Date: Jul. 10, 2025

(54) METHOD, APPARATUS, ELECTRONIC DEVICE, AND STORAGE MEDIUM FOR AUDIO PROCESSING

(71) Applicant: Beijing Zitiao Network Technology Co., Ltd., Beijing (CN)

(72) Inventors: Shichao Ge, Beijing (CN); Weisi Wang, Beijing (CN); Haixing Wang, Beijing (CN)

(21) Appl. No.: 18/941,333

(22) Filed: Nov. 8, 2024

(30) Foreign Application Priority Data
Jan. 8, 2024 (CN) 202410030700.9

(51) Int. Cl. H04S 7/00; H04S 3/00

(52) U.S. Cl. CPC H04S 7/301; H04S 3/008; H04S 2400/01; H04S 2400/13; H04S 2400/15; H04S 2420/07

(57) ABSTRACT

Embodiments of the present disclosure provide a method and apparatus, an electronic device, and a storage medium for audio processing. The method includes: determining a target impulse response for a first audio signal, and the target impulse response is a stereo impulse response for simulating a sound reflection and attenuation effect of the first audio signal in an acoustic space; obtaining a second audio signal by convolving the first audio signal with the target impulse response; and outputting a third audio signal by performing audio mixing on the first audio signal and the second audio signal. In the solution of the present disclosure, stereo impulse response data that can simulate a reflection and attenuation effect of a sound in a space is synchronously determined when reverberation is performed on an audio signal.

### CROSS-REFERENCE TO RELATED APPLICATION(S)

This application claims priority to Chinese Application No. 202410030700.9 filed Jan. 8, 2024, the disclosure of which is incorporated herein by reference in its entity.

### FIELD

Embodiments of the present disclosure relate to the field of computer technologies, and in particular, to a method and apparatus, an electronic device, and a storage medium for audio processing.

### BACKGROUND

With continuous development of science and technology, there are increasingly diversified audio signal processing means, such as the use of a reverberation technique to process an audio signal to simulate sound reflection and attenuation effects of the audio signal in different environments, to provide an immersive experience.

### SUMMARY

The present disclosure provides a method and apparatus, an electronic device, and a storage medium for audio processing, to achieve a more vivid reverberation effect of an audio signal, and improve sense of space and layering of a sound, so that the sound is richer and three-dimensional.

According to a first aspect, an embodiment of the present disclosure provides an audio processing method. The method includes:
determining a target impulse response for a first audio signal, and the target impulse response is a stereo impulse response for simulating a sound reflection and attenuation effect of the first audio signal in an acoustic space;
obtaining a second audio signal by convolving the first audio signal with the target impulse response; and
outputting a third audio signal by performing audio mixing on the first audio signal and the second audio signal.

According to a second aspect, an embodiment of the present disclosure further provides an apparatus for audio processing. The apparatus includes:
a determination module configured to determine a target impulse response for a first audio signal, and the target impulse response is a stereo impulse response for simulating a sound reflection and attenuation effect of the first audio signal in an acoustic space;
a reverberation processing module configured to obtain a second audio signal by convolving the first audio signal and the target impulse response; and
an audio output module configured to output a third audio signal by performing audio mixing on the first audio signal and the second audio signal.

According to a third aspect, an embodiment of the present disclosure further provides an electronic device. The electronic device includes:
at least one processor; and
a memory communicatively connected to the at least one processor, where
the memory stores a computer program executable by the at least one processor, and the computer program, when executed by the at least one processor, causes the at least one processor to perform the method for audio processing according to any of the above embodiments.

According to a fourth aspect, an embodiment of the present disclosure further provides a computer-readable medium storing computer instructions that, when executed by a processor, cause the audio processing method according to any of the above embodiments to be implemented.

In embodiments of the present disclosure, when the first audio signal is received, the target impulse response used to perform reverberation on the first audio signal is determined. The target impulse response is a stereo impulse response for simulating the sound reflection and attenuation effect of the first audio signal in the acoustic space. The reverberated second audio signal is obtained by convolving the first audio signal with the target impulse response. Then, the third audio signal may be output by performing audio mixing on the first audio signal and the second audio signal.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a method for audio processing according to an embodiment of the present disclosure;

FIG. 2a is a schematic diagram of sound after multiple reflections, scattering and attenuation according to an embodiment of the present disclosure;

FIG. 2b is a schematic signal diagram of an impulse response according to an embodiment of the present disclosure;

FIG. 2c is a schematic diagram of convolution and reverberation of an audio signal according to an embodiment of the present disclosure;

FIG. 3 is a schematic flowchart of another audio processing method according to an embodiment of the present disclosure;

FIG. 4 is a schematic diagram of principle of generating a stereo impulse response by a stereo impulse response generator according to an embodiment of the present disclosure;

FIG. 5 is a schematic diagram of a structure of an audio processing apparatus according to an embodiment of the present disclosure; and

FIG. 6 is a schematic diagram of a structure of an electronic device that implements an audio processing method according to an embodiment of the present disclosure.

### DETAILED DESCRIPTION OF EMBODIMENTS

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Mono impulse response data generated using a simulator is not realistic enough, resulting in a poor reverberation effect and a less natural and realistic sound, thus affecting the reverberation quality and fidelity, which in turn prevents the use of reverberation processing for sound effect generation from being widely popularized and applied.

FIG. 1 is a schematic flowchart of an audio processing method according to an embodiment of the present disclosure. This embodiment of the present disclosure is applicable to reverberation of an audio signal. The method may be performed by an audio processing apparatus. The audio processing apparatus may be implemented in the form of software and/or hardware, and is usually integrated into any electronic device having a network communication function. The electronic device may be a mobile terminal, a PC, a server, or the like.

As shown in FIG. 1, the audio processing method in this embodiment of the present disclosure may include the following process.

S110: determining a target impulse response for a first audio signal, and the target impulse response is a stereo impulse response for simulating a sound reflection and attenuation effect of the first audio signal in an acoustic space.

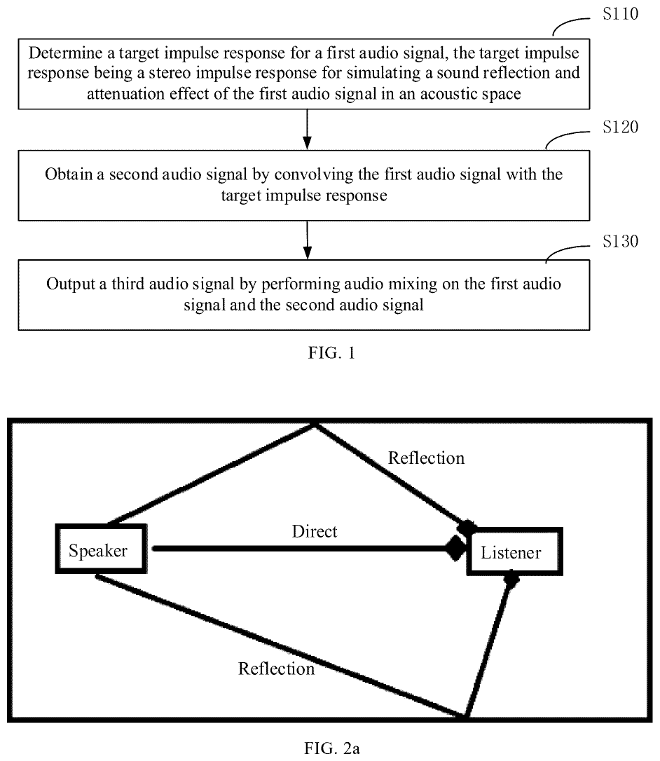

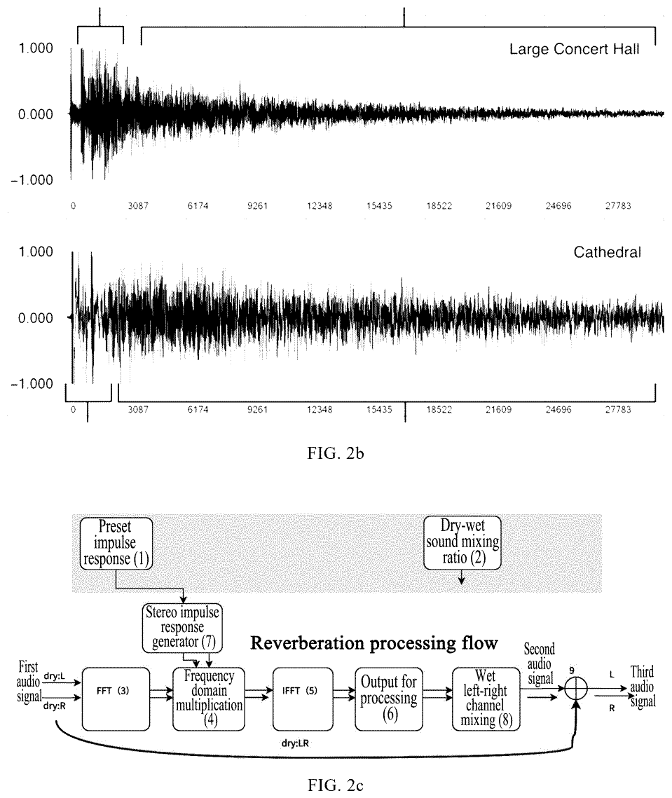

With reference to FIG. 2a, for the first audio signal emitted from a sound source, when propagated in a real or virtual acoustic space, the first audio signal interacts with an object in the acoustic space, causing sound reflection and attenuation. Such reflection and attenuation may affect a timbre, volume, duration, and the like of a sound. For example, when propagated indoors, the sound of the first audio signal is reflected by an obstacle such as a wall, a ceiling, or a floor, and is partially absorbed by the obstacle during each time of reflection. In this way, after sound emission is stopped, the sound is reflected and absorbed a plurality of times indoors before disappearing finally. This phenomenon is referred to as reverberation, and this period of time is referred to as reverberation time.

Reverberation describes an auditory feeling formed after the sound is reflected and attenuated a plurality of times in the acoustic space. A plurality of times of reflection, scattering, and attenuation of a “lingering sound” after a direct sound enhance sense of space, a sound depth, and articulation in terms of subjective auditory sense. With reference to FIG. 2b, to enable the first audio signal to have a reverberation effect, a corresponding target impulse response used to perform reverberation may be allocated to the first audio signal. The target impulse response is a stereo impulse response for simulating a sound reflection and attenuation effect of the first audio signal in a real or virtual acoustic space. The target impulse response is used as a mathematic model for simulating the sound reflection and attenuation effect, and may be generated based on a characteristic of the real or virtual acoustic space.

The stereo impulse response may describe a reflection and attenuation status of an input audio signal. The stereo impulse response includes an acoustic characteristic and space information. Through analysis on the stereo impulse response, responses at difference frequencies and a propagation and reflection status of the sound in the space may be obtained. In audio processing, the stereo impulse response is used to simulate different acoustic effects in a space, such as reverberation, reflection, and attenuation in a room. The target impulse response is applied to audio signal processing to simulate different acoustic reverberation effects in a space.

S120: Obtaining a second audio signal by convolving the first audio signal with the target impulse response.

For modeling-based implementation of a reverberation effect, the reverberation effect is usually implemented using a digital filter, such as a Schroeder algorithm and a Moorer algorithm. This type of algorithm is easy to implement, and has low calculation complexity. However, such reverberation has been lacking in realistic and natural enough. Therefore, after an appropriate stereo impulse response is generated for the first audio signal, the first audio signal may be convolved with the target impulse response to apply the target impulse response to audio signal processing to simulate different reverberation effects in a space. In this process, as stereo impulse response data, the target impulse response may simulate a reflection, scattering, and attenuation process of the sound in the space. Appropriate reverberation is performed on the first audio signal, so that the first audio signal may be more vivid, natural, three-dimensional, mellow, and clear.

Alternatively, during convolution of the first audio signal and the target impulse response, the target impulse response indicates a reflection and attenuation status of the sound of the first audio signal in the acoustic space. The target impulse response may be considered as a model function, and describes a status obtained after the sound is emitted from the sound source and reflected and attenuated a plurality of times in the acoustic space. Propagation and reflection of the sound in the acoustic space may be simulated by convolving the first audio signal with the target impulse response, to obtain the second audio signal with a reverberation effect.

In an alternative but nonrestrictive implementation, the obtaining a second audio signal by convolving the first audio signal with the target impulse response includes the following steps A1 and A2.

Step A1: convolving left- and right-channel audio signals of the first audio signal with the target impulse response respectively to obtain a left-channel audio processing result and a right-channel audio processing result corresponding to the first audio signal.

Step A2: performing left-right channel mixing on the left-channel audio processing result and the right-channel audio processing result corresponding to the first audio signal to output to left and right channels respectively, and generate the second audio signal with a stereo effect based on audio signals output to the left and right channels.

With reference to FIG. 2c, after the target impulse response for the first audio signal is determined, the first audio signal corresponds to the left-channel audio signal and the right-channel audio signal, the left-channel audio signal corresponding to the first audio signal is convolved with the target impulse response to obtain the left-channel audio processing result corresponding to the first audio signal, and the right-channel audio signal corresponding to the first audio signal is convolved with the target impulse response to obtain the right-channel audio processing result corresponding to the first audio signal.

With reference to FIG. 2c, for the left-channel audio processing result wet_L corresponding to the first audio signal and the right-channel audio processing result wet_R corresponding to the first audio signal, the left-channel audio processing result corresponding to the first audio signal may be mixed with a part of the right-channel audio processing result corresponding to the first audio signal, and a mixed result is output to the left channel. In addition, the right-channel audio processing result corresponding to the first audio signal may be further mixed with a part of the left-channel audio processing result corresponding to the first audio signal, and a mixed result is output to the right channel. Reverberation intensity of the left- and right-channel audio signals can be dynamically adjusted by performing left-right channel mixing on the left-channel audio processing result and the right-channel audio processing result respectively, and the audio signals output to the left and right channels are further mixed into the second audio signal with the stereo effect.

In an alternative but nonrestrictive implementation, convolving left- and right-channel audio signals of the first audio signal with the target impulse response respectively includes the following steps B1 to B3.

Step B1: performing framing and windowing on the left- and right-channel audio signals of the first audio signal respectively, and perform Fourier transform on each windowed left/right-channel audio frame segment respectively to obtain frequency domain results respectively corresponding to the left- and right-channel audio signals of the first audio signal.

Step B2: performing windowing on the target impulse response, and performing Fourier transform on the windowed target impulse response to obtain a frequency domain result of the target impulse response.

Step B3: performing frequency domain multiplication on the frequency domain results respectively corresponding to the left- and right-channel audio signals of the first audio signal and the frequency domain result of the target impulse response and then perform inverse Fourier transform respectively.

With reference to FIG. 2c, framing is respectively performed on the left- and right-channel audio signals of the input first audio signal. For example, the left-channel audio signal of the first audio signal is divided into segments of audio signals, each segment of signal is referred to as one frame and is denoted as one left-channel audio frame segment, and a frame length is usually 20 to 50 milliseconds. Further, a window function is applied to each left/right-channel audio frame segment, and a role of the window function is to gradually reduce a signal amplitude at a start position and an end position of the audio frame, to reduce discontinuity at a frame boundary. Common window functions include a rectangular window, a Hanning window, a Hamming window, and the like.

With reference to FIG. 2c, fourier transform (FFT) is respectively performed on each windowed left and right-channel audio frame segment, to obtain the frequency domain results respectively corresponding to the left- and right-channel audio signals of the first audio signal. In addition, a window function may be directly applied to the target impulse response, and Fourier transform is performed on the windowed target impulse response to obtain the frequency domain result of the target impulse response. Further, multiplication operations are respectively performed on the above frequency domain results respectively corresponding to the left- and right-channel audio signals of the first audio signal and the frequency domain result of the target impulse response, and multiplication results are transformed to time domain through inverse Fourier transform. Then, after data is spliced using an overlap-add method/overlap-save method, the left-channel audio processing result wet_L corresponding to the first audio signal and the right-channel audio processing result wet_R corresponding to the first audio signal are output.

Alternatively, transforming the multiplication results of the frequency domain results respectively corresponding to the left- and right-channel audio signals of the first audio signal and the frequency domain result of the target impulse response to time domain means that processing previously performed in frequency domain or another domain is transformed back to time domain. This may be implemented through inverse Fourier transform (IFFT) or another appropriate time domain transform method.

Alternatively, the overlap-add method or the overlap-save method for splicing data is a common data splicing method in signal processing, and is used to combine data processed in segments into one continuous output signal. Overlap-add method: In this method, adjacent audio frame segments have an overlapping part in terms of time. During splicing, an overlapping part of each audio frame segment is added to a start part of a next audio frame segment for smooth transition. Overlap-save method: This method is similar to the overlap-add method. However, during splicing, an overlapping part of each audio frame segment is saved instead of being added. In this way, more original audio signal information can be saved.

In an alternative but nonrestrictive implementation, performing left-right channel mixing on the left-channel audio processing result and the right-channel audio processing result corresponding to the first audio signal respectively to output to left and right channels includes the following steps C1 and C2.

Step C1: mixing the left-channel audio processing result corresponding to the first audio signal with the right-channel audio processing result corresponding to the first audio signal for output to the left channel based on a preset left-right channel mixing ratio.

Step C2: mixing the right-channel audio processing result corresponding to the first audio signal with the left-channel audio processing result corresponding to the first audio signal for output to the right channel based on a preset left-right channel mixing ratio to generate the second audio signal with the stereo effect.

The stereo effect obtained by mixing the left-channel audio processing result wet_L corresponding to the first audio signal and the right-channel audio processing result wet_R corresponding to the first audio signal is S. Mixing may be performed in the following process. For the left-channel audio processing result wet_L corresponding to the first audio signal and the right-channel audio processing result wet_R corresponding to the first audio signal, mixed left- and right-channel audio signals may be respectively calculated based on a mixing weight (for example, p) as follows:

$$left - channel input L = ( 1 - p ) * left - channel processing result + p * right - channel processing result$$

$$right - channel input R = ( 1 - p ) * right - channel processing result + p * left - channel processing result$$

The left-channel audio signal L and the right-channel audio signal R are respectively input to the left and right channels, to generate the stereo effect S. A value range of the mixing weight p is 0 to 1, and is used to control balance between the left and right channels. This may be set in response to a user operation to determine a value of the mixing weight.

S130: Outputting a third audio signal by performing audio mixing on the first audio signal and the second audio signal.

Alternatively, the first audio signal (dry sound) is mixed with the second audio signal (wet sound) according to a specified ratio, to obtain the third audio signal with a richer and more natural audio effect. For example, the first audio signal (dry sound) and the second audio signal (wet sound) are obtained, a dry-wet sound mixing ratio for the first audio signal (dry sound) and the second audio signal (wet sound) is determined, and the first audio signal (dry sound) is mixed with the second audio signal (wet sound) according to the determined dry-wet sound mixing ratio. This may be implemented through arithmetical operations such as an adder or a multiplier. The mixed third audio signal includes the first audio signal and a component of the processed second audio signal, to achieve a richer and more natural audio effect.

According to the technical solutions in this embodiment of the present disclosure, when the first audio signal is received, the target impulse response used to perform reverberation on the first audio signal is determined. The target impulse response is a stereo impulse response for simulating the sound reflection and attenuation effect of the first audio signal in the acoustic space. The reverberated second audio signal is obtained by convolving the first audio signal with the target impulse response. Then, the third audio signal may be output by performing audio mixing on the first audio signal and the second audio signal. This solution may resolve a problem that a reverberation effect is poor because mono impulse response data generated by a simulator is not real enough. Stereo impulse response data that may simulate a reflection and attenuation effect of a sound in a space is synchronously determined when reverberation is performed on an audio signal. Reverberation is performed on the audio signal by using the stereo impulse response data, so that it sounds as if the sound is generated in different space environments. In this way, a reverberation effect of the audio signal is more vivid, and sense of space and layering of the sound is improved, so that the sound is richer and three-dimensional.

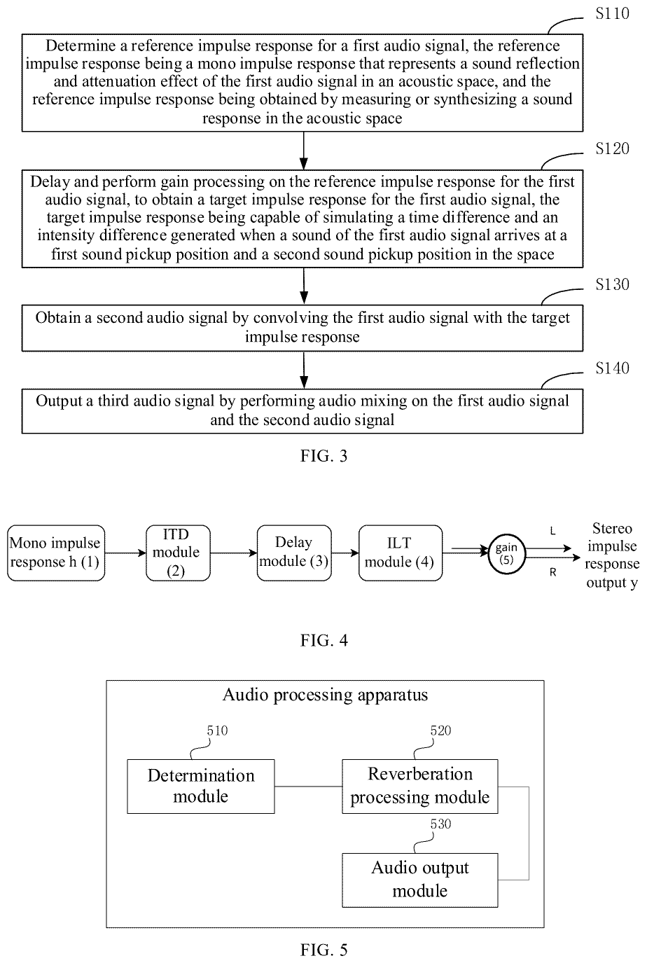

FIG. 3 is a schematic flowchart of another audio processing method according to an embodiment of the present disclosure. In the technical solution in this embodiment, based on the technical solution in the above embodiment, the process of determining the target impulse response for the first audio signal in the above embodiment is further optimized. This embodiment may be combined with optional solutions in one or more above embodiments.

As shown in FIG. 3, the audio processing method in this embodiment of the present disclosure may include the following process.

S310: determining a reference impulse response for the first audio signal, and the reference impulse response is a mono impulse response that represents the sound reflection and attenuation effect of the first audio signal in the acoustic space, and the reference impulse response is obtained by measuring or synthesizing a sound response in the acoustic space.

Alternatively, the reference impulse response is the mono impulse response that is collected in a real environment or that is obtained through physical modeling or psychoacoustic modeling.

During reverberation, a professional recording device is usually used to collect multi-channel impulse response data in a real environment, and then an input audio signal is processed by using the really collected impulse response data to generate sense of space of the sound. The professional recording device has a better effect in collecting the multi-channel impulse response data in the real environment for reverberation. However, the professional recording device is usually expensive, and needs to perform recoding in a specific environment. This may require additional costs. Consequently, sound effect generation performed through reverberation cannot be widely popularized and applied. Therefore, the mono impulse response may be obtained through physical modeling or psychoacoustic modeling.

S320: Delaying and performing gain processing on the reference impulse response for the first audio signal, to obtain the target impulse response for the first audio signal, the target impulse response being able to simulate a time difference and an intensity difference generated when a sound of the first audio signal arrives at a first sound pickup position and a second sound pickup position in the space.

The target impulse response is a stereo impulse response for simulating a sound reflection and attenuation effect of the first audio signal in an acoustic space.

With reference to FIG. 4, the reference impulse response for the first audio signal is used as an impulse response for reverberation, and may be from a mono impulse response collected in a real environment or obtained through physical modeling or psychoacoustic modeling. The time difference generated when a sound source of the first audio signal respectively arrives at the first sound pickup position and the second sound pickup position is determined, and the reference impulse response for the first audio signal is delayed based on the time difference, to simulate a time difference effect generated when the sound of the first audio signal arrives at the first sound pickup position and the second sound pickup position in the space. In addition, the intensity difference generated when the sound source of the first audio signal respectively arrives at the first sound pickup position and the second sound pickup position is determined, and the reference impulse response for the first audio signal is further gained based on the intensity difference, to simulate an intensity difference effect generated when the sound of the first audio signal arrives at the first sound pickup position and the second sound pickup position in the space.

With reference to FIG. 4, the time difference generated when the sound source of the first audio signal respectively arrives at the first sound pickup position and the second sound pickup position may be calculated by using an ITD algorithm, and a sound pressure level difference generated due to different intensities when the sound source of the first audio signal respectively arrives at the first sound pickup position and the second sound pickup position may be calculated by using an ILD algorithm. Parameters of the ITD algorithm and parameters of the ILT algorithm each include: a distance T between the first sound pickup position and the second sound pickup position, a distance d from the sound source to the first sound pickup position, an included angle direction θ of the sound source relative to a perpendicular bisector of a connection line between the first sound pickup position and the second sound pickup position, and a propagation velocity c of the sound in the air.

In an alternative but nonrestrictive implementation, delaying and performing gain processing on the reference impulse response for the first audio signal, to obtain the target impulse response for the first audio signal includes the following steps D1 to D3.

Step D1: Determining, as a target time difference, a difference between the times at which the sound source of the first audio signal respectively arrives at the first sound pickup position and the second sound pickup position.

With reference to FIG. 4, a time difference from the sound source to the first sound pickup position is calculated. The time difference from the sound source to the first sound pickup position may be calculated based on the propagation velocity of the sound in the air. The following formula may be used for calculation: Δt=d/c. Δt represents the time difference from the sound source to the first sound pickup position, d represents the distance from the sound source to the first sound pickup position, and c represents the propagation velocity of the sound in the air. The difference between time of arrival at the first sound pickup position and the second sound pickup position is calculated as follows: The difference between time of arrival at the first sound pickup position and the second sound pickup position may be calculated based on the included angle direction θ of the sound source relative to the perpendicular bisector of the connection line between the first sound pickup position and the second sound pickup position and the distance between the first sound pickup position and the second sound pickup position. The following formula may be used for calculation: ITD=T*sin(θ)/c. ITD represents the time difference between the first sound pickup position and the second sound pickup position, T represents the distance between the first sound pickup position and the second sound pickup position, θ represents the included angle direction θ of the sound source relative to the perpendicular bisector of the connection line between the first sound pickup position and the second sound pickup position, and c represents the propagation velocity of the sound in the air.

Step D2: Determining, as a target intensity difference, a sound pressure level difference generated due to different intensities when the sound source of the first audio signal respectively arrives at the first sound pickup position and the second sound pickup position.

With reference to FIG. 4, a difference between distances from the sound source of the first audio signal to the first sound pickup position and the second sound pickup position is calculated as follows: The difference Δd between the distances from the sound source to the first sound pickup position and the second sound pickup position is calculated based on a distance d from the sound source of the first audio signal to a center of the connection line between the first sound pickup position and the second sound pickup position and the included angle direction θ of the sound source relative to the perpendicular bisector of the connection line between the first sound pickup position and the second sound pickup position. The following formula may be used for calculation: Δd=T*sin(θ). An amplitude ratio between the first sound pickup position and the second sound pickup position is calculated as follows: The amplitude ratio α between the first sound pickup position and the second sound pickup position may be calculated based on the difference Δd between the distances from the sound source of the first audio signal to the first sound pickup position and the second sound pickup position. The following formula may be used for calculation: α=(d+Δd)/(d−Δd).

Step D3: Delaying the reference impulse response for the first audio signal based on the target time difference, and after the reference impulse response for the first audio signal is delayed, performing gain processing on the reference impulse response for the first audio signal based on the target time difference, to obtain the target impulse response for the first audio signal.

With reference to FIG. 4, the reference impulse response for the first audio signal is delayed by the time difference ITD, to simulate a time difference (between a left ear and a right ear) generated when the sound of the first audio signal arrives at different positions in the acoustic space. A delay module in a digital signal processing technology may be used for implementation. After the reference impulse response for the first audio signal is delayed, the reference impulse response for the first audio signal may be further gained, to simulate an amplitude difference between the first sound pickup position and the second sound pickup position. The gain processing may be implemented by multiplying the reference impulse response signal for the first audio signal by the amplitude ratio α.

S330: Obtaining a second audio signal by convolving the first audio signal with the target impulse response.

S340: Outputting a third audio signal by performing audio mixing on the first audio signal and the second audio signal.

According to the technical solutions in this embodiment of the present disclosure, when the first audio signal is received, the target impulse response used to perform reverberation on the first audio signal is determined. The target impulse response is a stereo impulse response for simulating the sound reflection and attenuation effect of the first audio signal in the acoustic space. The reverberated second audio signal is obtained by convolving the first audio signal with the target impulse response. Then, the third audio signal may be output by performing audio mixing on the first audio signal and the second audio signal. This solution may resolve a problem that a reverberation effect is poor because mono impulse response data generated by a simulator is not real enough. Stereo impulse response data that can simulate a reflection and attenuation effect of a sound in a space is synchronously determined when reverberation is performed on an audio signal. Reverberation is performed on the audio signal by using the stereo impulse response data, so that it sounds as if the sound is generated in different space environments. In this way, a reverberation effect of the audio signal is more vivid, and sense of space and layering of the sound is improved, so that the sound is richer and three-dimensional.

FIG. 5 is a schematic diagram of a structure of an audio processing apparatus according to an embodiment of the present disclosure. This embodiment of the present disclosure is applicable to reverberation of an audio signal. The audio processing apparatus may be implemented in the form of software and/or hardware, and is usually integrated into any electronic device having a network communication function. The electronic device may be a mobile terminal, a PC, a server, or the like.

As shown in FIG. 5, the audio processing apparatus in this embodiment of the present disclosure may include: a determination module 510, a reverberation processing module 520, and an audio output module 530.

The determination module 510 is configured to determine a target impulse response for a first audio signal, and the target impulse response is a stereo impulse response for simulating a sound reflection and attenuation effect of the first audio signal in an acoustic space.

The reverberation processing module 520 is configured to obtain a second audio signal by convolving the first audio signal with the target impulse response.

The audio output module 530 is configured to output a third audio signal by performing audio mixing on the first audio signal and the second audio signal.

Based on the technical solutions in the above embodiments, alternatively, determining a target impulse response for a first audio signal includes:
determining a reference impulse response for the first audio signal, and the reference impulse response is a mono impulse response that represents the sound reflection and attenuation effect of the first audio signal in the acoustic space, and the reference impulse response is obtained by measuring or synthesizing a sound response in the acoustic space; and
delaying and performing gain processing on the reference impulse response for the first audio signal, to obtain the target impulse response for the first audio signal, the target impulse response being able to simulate a time difference and an intensity difference generated when a sound of the first audio signal arrives at a first sound pickup position and a second sound pickup position in the space.

Based on the technical solutions in the above embodiments, alternatively, the reference impulse response is the mono impulse response that is collected in a real environment or that is obtained through physical modeling or psychoacoustic modeling.

Based on the technical solutions in the above embodiments, alternatively, delaying and performing gain processing on the reference impulse response for the first audio signal, to obtain the target impulse response for the first audio signal includes:
determining, as a target time difference, a difference between the times at which a sound source of the first audio signal arrives at the first sound pickup position and the second sound pickup position respectively;
determining, as a target intensity difference, a sound pressure level difference generated due to different intensities when the sound source of the first audio signal arrives at the first sound pickup position and the second sound pickup position respectively; and
delaying the reference impulse response for the first audio signal based on the target time difference, and after the reference impulse response for the first audio signal is delayed, performing gain processing on the reference impulse response for the first audio signal based on the target time difference, to obtain the target impulse response for the first audio signal.

Based on the technical solutions in the above embodiments, alternatively, obtaining a second audio signal by convolving the first audio signal with the target impulse response includes:
convolving left- and right-channel audio signals of the first audio signal with the target impulse response respectively, to obtain a left-channel audio processing result and a right-channel audio processing result corresponding to the first audio signal; and
performing left and right-channel mixing respectively on the left-channel audio processing result and the right-channel audio processing result corresponding to the first audio signal for output to left and right channels, and generating the second audio signal with a stereo effect based on audio signals output to the left and right channels.

Based on the technical solutions in the above embodiments, alternatively, convolving left- and right-channel audio signals of the first audio signal with the target impulse response respectively includes:
performing framing and windowing on the left- and right-channel audio signals of the first audio signal respectively, and respectively performing Fourier transform on each windowed left- and right-channel audio frame segment to obtain frequency domain results respectively corresponding to the left- and right-channel audio signals of the first audio signal;
performing windowing on the target impulse response, and performing Fourier transform on the windowed target impulse response, to obtain a frequency domain result for the target impulse response; and
respectively performing frequency domain multiplication on the frequency domain results respectively corresponding to the left- and right-channel audio signals of the first audio signal and the frequency domain result for the target impulse response, and then performing inverse Fourier transform.

Based on the technical solutions in the above embodiments, alternatively, performing left-right channel mixing on the left-channel audio processing result and the right-channel audio processing result corresponding to the first audio signal respectively to output to left and right channels includes:
mixing the left-channel audio processing result corresponding to the first audio signal with the right-channel audio processing result corresponding to the first audio signal to output to the left channel based on a preset left-right channel mixing ratio; and
mixing the right-channel audio processing result corresponding to the first audio signal with the left-channel audio processing result corresponding to the first audio signal to output to the right channel based on a preset left-right channel mixing ratio, to generate the second audio signal with the stereo effect.

According to the technical solutions in this embodiment of the present disclosure, when the first audio signal is received, the target impulse response used to perform reverberation on the first audio signal is determined. The target impulse response is a stereo impulse response for simulating the sound reflection and attenuation effect of the first audio signal in the acoustic space. The reverberated second audio signal is obtained by convolving the first audio signal with the target impulse response. Then, the third audio signal may be output by performing audio mixing on the first audio signal and the second audio signal. This solution can resolve a problem that a reverberation effect is poor because mono impulse response data generated by a simulator is not real enough. Stereo impulse response data that can simulate a reflection and attenuation effect of a sound in a space is synchronously determined when reverberation is performed on an audio signal. Reverberation is performed on the audio signal by using the stereo impulse response data, so that it sounds as if the sound is generated in different space environments. In this way, a reverberation effect of the audio signal is more vivid, and sense of space and layering of the sound is improved, so that the sound is richer and three-dimensional.

The audio processing apparatus provided in this embodiment of the present disclosure may perform the audio processing method provided in any of the embodiments of the present disclosure, and has corresponding functional modules and beneficial effects for performing the audio processing method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

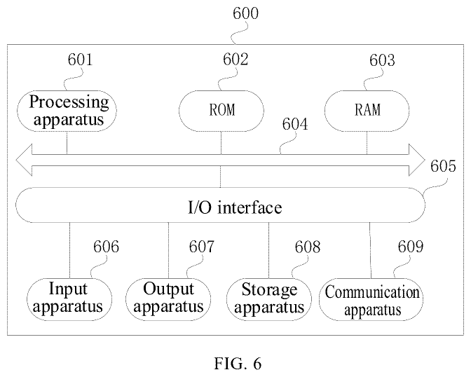

FIG. 6 is a schematic diagram of a structure of an electronic device according to an embodiment of the present disclosure. Reference is made to FIG. 6 below, which is a schematic diagram of a structure of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (for example, a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium. The computer program includes program code for performing the audio processing method shown in the flowchart. In such an embodiment, the computer program may be downloaded from a network through the communication apparatus 609 and installed, installed from the storage apparatus 608, or installed from the ROM 602. When the computer program is executed by the processing apparatus 601, the above functions defined in the audio processing method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the audio processing method provided in the above embodiment belong to the same inventive concept. For the technical details not described in detail in this embodiment, reference can be made to the above embodiment, and this embodiment and the above embodiment have the same beneficial effects.

An embodiment of the present disclosure provides a computer storage medium storing a computer program thereon. When executed by a processor, the program implements the audio processing method provided in the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), or the like, or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determine a target impulse response for a first audio signal, the target impulse response being a stereo impulse response for simulating a sound reflection and attenuation effect of the first audio signal in an acoustic space; obtain a second audio signal by convolving the first audio signal with the target impulse response; and output a third audio signal by performing audio mixing on the first audio signal and the second audio signal.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for audio processing, comprising:
determining a target impulse response for a first audio signal, the target impulse response being a stereo impulse response for simulating a sound reflection and attenuation effect of the first audio signal in an acoustic space;
obtaining a second audio signal by convolving the first audio signal with the target impulse response; and
outputting a third audio signal by performing audio mixing on the first audio signal and the second audio signal.

2. The method according to claim 1, wherein determining a target impulse response for a first audio signal comprises:
determining a reference impulse response for the first audio signal, the reference impulse response being a mono impulse response that represents the sound reflection and attenuation effect of the first audio signal in the acoustic space, and the reference impulse response being obtained by measuring or synthesizing a sound response in the acoustic space; and
delaying and performing gain processing on the reference impulse response for the first audio signal, to obtain the target impulse response for the first audio signal, the target impulse response being capable of simulating a time difference and an intensity difference generated in response to a sound of the first audio signal arriving at a first sound pickup position and a second sound pickup position in the space.

3. The method according to claim 2, wherein the reference impulse response is the mono impulse response that is collected in a real environment or that is obtained through physical modeling or psychoacoustic modeling.

4. The method according to claim 2, wherein delaying and performing gain processing on the reference impulse response for the first audio signal, to obtain the target impulse response for the first audio signal comprises:
determining, as a target time difference, a difference between the times at which a sound source of the first audio signal arrives at the first sound pickup position and the second sound pickup position respectively;
determining, as a target intensity difference, a sound pressure level difference generated due to different intensities in response to the sound source of the first audio signal arriving at the first sound pickup position and the second sound pickup position respectively; and
delaying the reference impulse response for the first audio signal based on the target time difference, and after the reference impulse response for the first audio signal is delayed, performing gain processing on the reference impulse response for the first audio signal based on the target time difference, to obtain the target impulse response for the first audio signal.

5. The method according to claim 1, wherein obtaining a second audio signal by convolving the first audio signal with the target impulse response comprises:
convolving left- and right-channel audio signals of the first audio signal with the target impulse response respectively, to obtain a left-channel audio processing result and a right-channel audio processing result corresponding to the first audio signal; and
performing left and right-channel mixing respectively on the left-channel audio processing result and the right-channel audio processing result corresponding to the first audio signal for output to left and right channels, and generating the second audio signal with a stereo effect based on audio signals output to the left and right channels.

6. The method according to claim 5, wherein convolving left- and right-channel audio signals of the first audio signal with the target impulse response respectively comprises:
performing framing and windowing on the left- and right-channel audio signals of the first audio signal respectively, and performing Fourier transform on each windowed left- and right-channel audio frame segment, to obtain frequency domain results respectively corresponding to the left- and right-channel audio signals of the first audio signal;
performing windowing on the target impulse response, and performing Fourier transform on the windowed target impulse response, to obtain a frequency domain result for the target impulse response; and
respectively performing frequency domain multiplication on the frequency domain results respectively corresponding to the left- and right-channel audio signals of the first audio signal and the frequency domain result for the target impulse response, and then performing inverse Fourier transform.

7. The method according to claim 5, wherein performing left and right-channel mixing on the left-channel audio processing result and the right-channel audio processing result corresponding to the first audio signal respectively to output to left and right channels comprises:
mixing the left-channel audio processing result corresponding to the first audio signal with the right-channel audio processing result corresponding to the first audio signal to output to the left channel based on a preset left-right channel mixing ratio; and
mixing the right-channel audio processing result corresponding to the first audio signal with the left-channel audio processing result corresponding to the first audio signal to output to the right channel based on a preset left-right channel mixing ratio, to generate the second audio signal with the stereo effect.

8. An electronic device, comprising:
one or more processors; and
a memory configured to store one or more programs, wherein
the one or more programs, when executed by the one or more processors, cause the one or more processors to:
determine a target impulse response for a first audio signal, wherein the target impulse response is a stereo impulse response for simulating a sound reflection and attenuation effect of the first audio signal in an acoustic space;
obtain a second audio signal by convolving the first audio signal with the target impulse response; and
output a third audio signal by performing audio mixing on the first audio signal and the second audio signal.

9. The electronic device according to claim 8, wherein the one or more programs causing the one or more processors to determine a target impulse response for a first audio signal comprise instructions to:
determine a reference impulse response for the first audio signal, wherein the reference impulse response is a mono impulse response that represents the sound reflection and attenuation effect of the first audio signal in the acoustic space, and the reference impulse response is obtained by measuring or synthesizing a sound response in the acoustic space; and
delay and perform gain processing on the reference impulse response for the first audio signal, to obtain the target impulse response for the first audio signal, wherein the target impulse response is able to simulate a time difference and an intensity difference generated in response to a sound of the first audio signal arriving at a first sound pickup position and a second sound pickup position in the space.

10. The electronic device according to claim 9, wherein the reference impulse response is the mono impulse response that is collected in a real environment or that is obtained through physical modeling or psychoacoustic modeling.

11. The electronic device according to claim 9, wherein the one or more programs causing the one or more processors to delay and perform gain processing on the reference impulse response for the first audio signal, to obtain the target impulse response for the first audio signal comprise instructions to:
determine, as a target time difference, a difference between the times at which a sound source of the first audio signal arrives at the first sound pickup position and the second sound pickup position respectively;
determine, as a target intensity difference, a sound pressure level difference generated due to different intensities in response to the sound source of the first audio signal arriving at the first sound pickup position and the second sound pickup position respectively; and
delay the reference impulse response for the first audio signal based on the target time difference, and after the reference impulse response for the first audio signal is delayed, performing gain processing on the reference impulse response for the first audio signal based on the target time difference, to obtain the target impulse response for the first audio signal.

12. The electronic device according to claim 8, wherein the one or more programs causing the one or more processors to obtain a second audio signal by convolving the first audio signal with the target impulse response comprise instructions to:
convolve left- and right-channel audio signals of the first audio signal with the target impulse response respectively, to obtain a left-channel audio processing result and a right-channel audio processing result corresponding to the first audio signal; and
perform left and right-channel mixing respectively on the left-channel audio processing result and the right-channel audio processing result corresponding to the first audio signal for output to left and right channels, and generating the second audio signal with a stereo effect based on audio signals output to the left and right channels.

13. The electronic device according to claim 12, wherein the one or more programs causing the one or more processors to convolve left- and right-channel audio signals of the first audio signal with the target impulse response respectively comprise instructions to:
perform framing and windowing on the left- and right-channel audio signals of the first audio signal respectively, and performing Fourier transform on each windowed left- and right-channel audio frame segment, to obtain frequency domain results respectively corresponding to the left- and right-channel audio signals of the first audio signal;
perform windowing on the target impulse response, and performing Fourier transform on the windowed target impulse response, to obtain a frequency domain result for the target impulse response; and
respectively perform frequency domain multiplication on the frequency domain results respectively corresponding to the left- and right-channel audio signals of the first audio signal and the frequency domain result for the target impulse response, and then performing inverse Fourier transform.

14. The electronic device according to claim 12, wherein the one or more programs causing the one or more processors to perform left and right-channel mixing on the left-channel audio processing result and the right-channel audio processing result corresponding to the first audio signal respectively to output to left and right channels comprises instructions to:
mix the left-channel audio processing result corresponding to the first audio signal with the right-channel audio processing result corresponding to the first audio signal to output to the left channel based on a preset left-right channel mixing ratio; and
mix the right-channel audio processing result corresponding to the first audio signal with the left-channel audio processing result corresponding to the first audio signal to output to the right channel based on a preset left-right channel mixing ratio, to generate the second audio signal with the stereo effect.

15. A non-transitory storage medium comprising computer-executable instructions, wherein the computer-executable instructions, when executed by a computer processor, causing the computer processor to:
determine a target impulse response for a first audio signal, wherein the target impulse response is a stereo impulse response for simulating a sound reflection and attenuation effect of the first audio signal in an acoustic space;
obtain a second audio signal by convolving the first audio signal with the target impulse response; and
output a third audio signal by performing audio mixing on the first audio signal and the second audio signal.

16. The medium according to claim 15, wherein the computer-executable instructions causing the computer processor to determine a target impulse response for a first audio signal comprise instructions to:
determine a reference impulse response for the first audio signal, wherein the reference impulse response is a mono impulse response that represents the sound reflection and attenuation effect of the first audio signal in the acoustic space, and the reference impulse response is obtained by measuring or synthesizing a sound response in the acoustic space; and
delay and perform gain processing on the reference impulse response for the first audio signal, to obtain the target impulse response for the first audio signal, wherein the target impulse response is able to simulate a time difference and an intensity difference generated in response to a sound of the first audio signal arriving at a first sound pickup position and a second sound pickup position in the space.

17. The medium according to claim 16, wherein the reference impulse response is the mono impulse response that is collected in a real environment or that is obtained through physical modeling or psychoacoustic modeling.

18. The medium according to claim 16, wherein the computer-executable instructions causing the computer processor to delay and perform gain processing on the reference impulse response for the first audio signal, to obtain the target impulse response for the first audio signal comprise instructions to:
determine, as a target time difference, a difference between the times at which a sound source of the first audio signal arrives at the first sound pickup position and the second sound pickup position respectively;
determine, as a target intensity difference, a sound pressure level difference generated due to different intensities in response to the sound source of the first audio signal arriving at the first sound pickup position and the second sound pickup position respectively; and
delay the reference impulse response for the first audio signal based on the target time difference, and after the reference impulse response for the first audio signal is delayed, performing gain processing on the reference impulse response for the first audio signal based on the target time difference, to obtain the target impulse response for the first audio signal.

19. The medium according to claim 15, wherein the computer-executable instructions causing the computer processor to obtain a second audio signal by convolving the first audio signal with the target impulse response comprise instructions to:
convolve left- and right-channel audio signals of the first audio signal with the target impulse response respectively, to obtain a left-channel audio processing result and a right-channel audio processing result corresponding to the first audio signal; and
perform left and right-channel mixing respectively on the left-channel audio processing result and the right-channel audio processing result corresponding to the first audio signal for output to left and right channels, and generating the second audio signal with a stereo effect based on audio signals output to the left and right channels.

20. The medium according to claim 19, wherein the computer-executable instructions causing the computer processor to convolve left- and right-channel audio signals of the first audio signal with the target impulse response respectively comprise instructions to:
perform framing and windowing on the left- and right-channel audio signals of the first audio signal respectively, and performing Fourier transform on each windowed left- and right-channel audio frame segment, to obtain frequency domain results respectively corresponding to the left- and right-channel audio signals of the first audio signal;
perform windowing on the target impulse response, and performing Fourier transform on the windowed target impulse response, to obtain a frequency domain result for the target impulse response; and
respectively perform frequency domain multiplication on the frequency domain results respectively corresponding to the left- and right-channel audio signals of the first audio signal and the frequency domain result for the target impulse response, and then performing inverse Fourier transform.
